(19) United States
(12) Patent Application Publication
(10) Pub. No.: US 2008/0255806 A1
(43) Pub. Date: Oct. 16, 2008

(54) Pole Monitoring Kit, in Particular for Wooden Poles

(76) Inventors: Luigi Sambuelli, Torino (IT); Giovanni Nicolotti, Torino (IT); Domenico Lopreiato, Torino (IT)

Correspondence Address: NIXON & VANDERHYE, PC, 901 NORTH GLEBE ROAD, 11TH FLOOR, ARLINGTON, VA, 22203, US

(21) Appl. No.: 12/067,363

(22) PCT Filed: Oct. 31, 2006
(86) PCT No.: PCT/IB2006/054293

§ 371 Date: Mar. 19, 2008

(30) Foreign Application Priority Data
Nov. 4, 2005 (IT) TO2005A000783

(51) Int. Cl. G21C 17/00

(52) U.S. Cl. 702/183

(57) ABSTRACT

Kit for monitoring poles, in particular wooden poles, that comprises: a detection device (10) comprising at least one collar (11) to be secured to a pole (20) to be evaluated, said at least one collar (11) bearing one or more sensors (12) capable of detecting a response determined by the percussion of said pole (20),—a percussion device (16) to stress said pole (20) and determine said response;—a data transmission system (13) in signal connection with said one or more sensors (12) to receive the values measured from them;—a portable computer (15) to receive and process the data transmitted via said data transmission system (13) from the detection device (10) to achieve monitoring of the damage produced by degradation.

### FIELD OF THE INVENTION

The present invention relates to a kit for monitoring poles, in particular wooden poles, such as for example poles for telephone lines. Although the present invention was developed with reference to poles for telephone lines, the invention is applicable to any field in which a support element is present that operates in conditions similar to those in which said wooden poles operate.

As a general introduction to the description of the prior art, of the problems underlying the invention and of the solution proposed here, it would appear useful to summarise some essential features of the technical field of which the invention forms part.

### DESCRIPTION OF THE PRIOR ART

Telephone lines are, as is known, distributed throughout the territory employing poles to support telephone cables. As an example, Italian telephone lines are distributed throughout the territory by a network that comprises approximately 3,000,000 poles. The duration in service of each pole is limited, in particular to approximately 25 years, so that, with the data indicated above, this produces a need to check approximately 300,000 poles per year and to replace those that are damaged.

This requirement for periodic monitoring of all poles distributed throughout the territory originates from the need to evaluate their soundness, in order to protect the safety and security of the operators who must climb up on the poles to carry out line maintenance operations.

The parts of the pole that are most exposed to risks of alteration are the sections of the pole corresponding to the constraint interface with the ground and the buried sections, both from the standpoint of mechanical stress and from that of degradation by wood-eating insects and fungi. Such alterations, also accentuated by microclimatic conditions that are favourable to these processes in terms of temperature and humidity, modify the mechanical and shape properties of the system (elastic modulus, density, moment of inertia) and decrease the area of the useful resistant section thus deteriorating the static and dynamic properties.

At the current state of technology, methods are known to evaluate the stability and soundness of poles. The simplest method is based on visual evaluation: observation of cavities around the point of insertion into the ground indicates poles in a poor condition that should be replaced.

Some methods are also known that envisage evaluation employing specific instruments, in some cases in combination with visual evaluation: this instrumental evaluation may be performed employing a hammer (impulse hammer) to provoke a mechanical and/or acoustic response which is evaluated by inserting sensors into the pole, which measure its acoustic response in terms of the speed of propagation of sound waves, and its mechanical response in terms of flexural vibrations.

An instrumental evaluation may also be made by using the instruments known, respectively, as the Resistograph® and the Polux®.

The Resistograph® essentially consists of a penetrometer that measures the resistance of the wood to perforation by a probe. This instrument, although it only makes very small holes (2 mm) must be considered invasive. The basic apparatus comprises a perforating drill, equipped with a probe of variable length (from 40 to 150 cm) that advances at a constant velocity, which can be regulated as a function of the density of the wood to be examined. The energy consumed during the drilling, which can be visualised graphically through a specific dendrogram printed at the same time as the drilling is performed, becomes a measurement of the mechanical qualities of the wood. Decayed wood, opposing lower resistance to drilling, generally determines a reduction in the dendrogram.

This method presents the disadvantage of performing punctiform investigation of the point-form type, thus providing indications on the cross-section, making it necessary to drill a series of holes for an exhaustive investigation of the extension of the decay, with consequent increase in the invasive nature of the test. Furthermore, the dendrogram is not easy to interpret and must be read by an expert. Lastly, to facilitate measurement of poles it is necessary to clear earth away from the area around the point of insertion of the pole into the ground.

The Polux®, developed by Lausanne Polytechnic, is based on the principle whereby degraded wood is more humid and thus more conductive, so that its electrical resistance decreases. The instrument is applied at the base of the pole with a belt; by operating a lever, two electrodes in the form of nails are inserted into the pole, and the force needed to insert them is measured. Subsequently, thanks to contemporary measurement of electrical resistance, the humidity is also measured.

In order to facilitate measurement on the poles, the Polux® system, as likewise the Resistograph® system, requires the point of insertion into the ground to be cleared of soil. Furthermore, in this case too the analysis is invasive. Lastly, to provide a response, at the least two measurements of a very different nature must be made.

Alongside the two systems mentioned above, a system known as the PoleTest™ is also known; this was created specifically to investigate wooden poles for telephone lines. In this system, two sensors are inserted into the pole and are struck to produce a wave that propagates from one sensor to the other and is detected by the sensors. From the close relation that exists between the time of propagation between the two sensors and the strength of the wood, an estimate of the condition of the pole may be made. However this, too, is an invasive system. The systems described envisage the insertion of sensors into the wood, and are thus invasive; the instruments are also frequently cumbersome.

Further information with regard to the prior art may also be found for example in the publications:
“In service wooden poles evaluation”, J. L. Sandoz e Y. Benoit, Cired, Regional Symposium and Exhibition on Electricity Distribution 2002, 5-8 Aug. 2002, Kuala Lumpur, Malaysia;
“Non Destructive Testing for Assessing Wood Members in Structures. A review”, R. J. Ross, R. F. Pellerin, United States Department of Agriculture Forest Service, Forest Products Laboratory General Technical Report FPL-GTR-70.

### PURPOSE AND SUMMARY OF THE INVENTION

The purpose of the present invention is that of solving the problem indicated above in a simple and effective manner, providing a monitoring solution of the non-invasive type and, at the same time, a solution that is economic, portable, light and easy to use in a repeatable manner, that drastically reduces costs and times for the maintenance and monitoring of said poles.

In view of achieving this purpose, the subject of the invention is a kit for monitoring poles having the characteristics indicated in the annexed claim 1, as well as a corresponding process and computer program product. Preferred embodiments of such kit form the subject of the subsequent dependent claims.

### BRIEF DESCRIPTION OF THE ANNEXED DRAWINGS

The invention will now be described, as a simple example without limiting intent, with reference to the attached drawings, in which:

FIG. 1 represents a view, in diagram form, of the kit according to the invention;

FIG. 2 represents a view, in diagram form, of the kit according to the invention in use configuration;

FIGS. 3a and 3b represent diagrams of quantities that can be visualised with the kit according to the invention;

FIG. 4 represents a view, in diagram form, of the kit in transport configuration;

FIG. 5 represents a diagram illustrating a step in the monitoring process implemented through a kit according to the invention;

FIG. 6 represents a section, in diagram form, of a pole monitored employing the kit according to the invention.

### DETAILED DESCRIPTION OF EXAMPLES OF EMBODIMENTS OF THE INVENTION

The invention in question relates in particular to a portable kit to evaluate the stability and risk of breakage of wooden poles for telephone lines that substantially comprises:

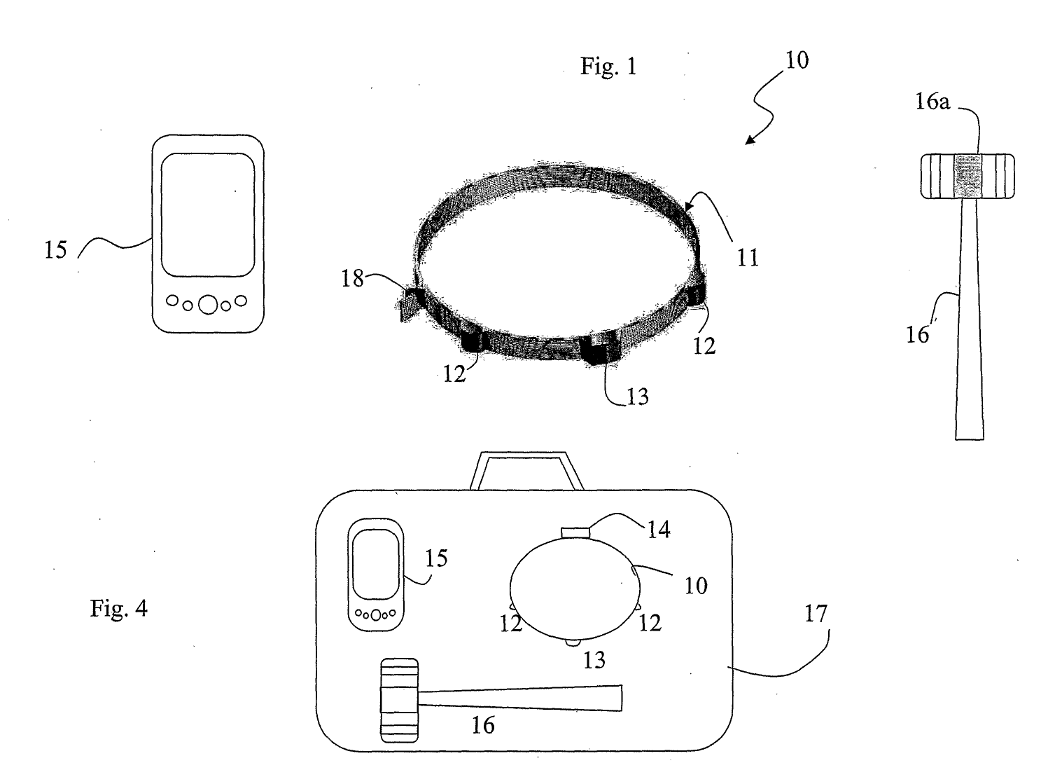

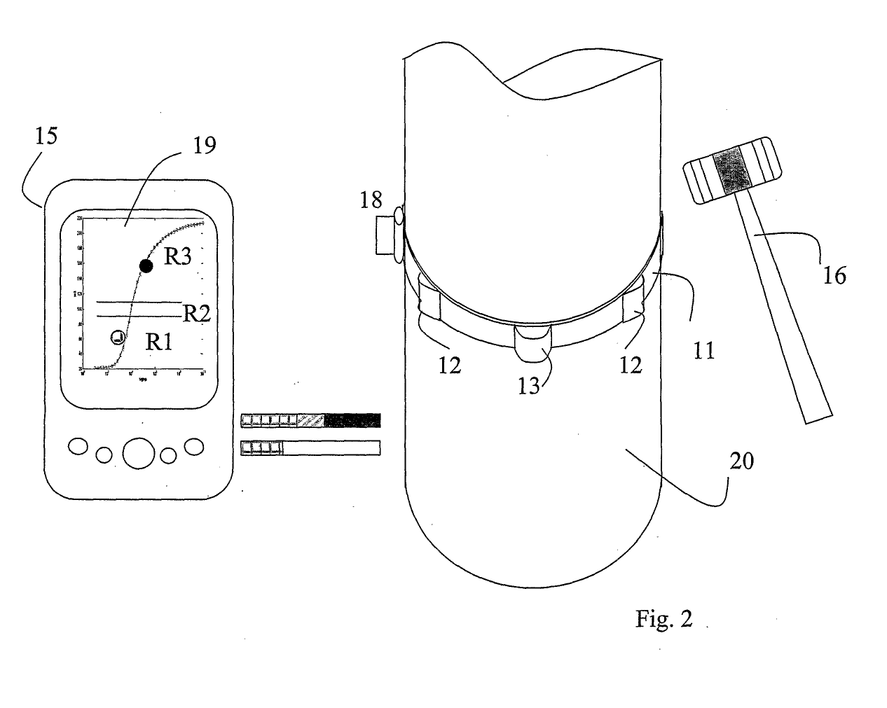

a detector device, indicated as a whole with reference 10 in FIG. 1, comprising in its turn a collar 11 to enable the detection device 10 to be attached to a pole whose condition is to be monitored, indicated with 20 in FIG. 2. The collar 11 is substantially a strip of metal or fabric or polymer, to which are associated a plurality of acceleration sensors 12. The outputs of these acceleration sensors 12 are in signal connection with a data transmission system 13 for wireless transmission of the measurements from said acceleration sensors 12. The data transfer system 13 is likewise affixed to the collar 11, as is likewise a power supply unit 14, not shown in FIG. 1 but shown in FIG. 4, that provides power to the transfer system 13 and in some cases to the acceleration sensors 12, if they so require;

a portable computer 15, in particular a multimedia palmtop computer, for the reception and processing of data relating to measurements made by the sensors 12, transmitted through the data transfer system 13 from the detection device 10;

a percussion device 16, in particular a percussion hammer, if required instrumented and/or calibrated, i.e. bearing a module 16a to measure and transmit the transferred impulse;

a carrying case 17, shown in FIG. 4, to transport the parts of the above kit.
The power supply unit 14 for preference comprises a power supply with rechargeable batteries, but may also be a transformer or an electric socket to which the operator connects, through a specific cable, a separate battery or power supply.
   The monitoring kit according to the invention operates as follows.

The collar 11 is fixed by an operator onto the pole 20, as shown in FIG. 2, securing it with a fastener 18, which in a preferred embodiment can be adjusted so as to adapt the overall circumference of the collar 11 to the specific section of the pole 20 to which it is applied. The sensors 12 remain in contact with the pole 20, in a condition suitable for measuring said pole, thanks to the friction generated by clamping with the fastener 18. The pole 20 is then stressed by means of a percussion hammer 16; the acceleration sensors 12 detect the dynamic response of the system comprising the pole 20, integral with the ground into which is placed, and send the data relating to such dynamic response by means of the data transfer unit 13, which preferably is a wireless transmission unit, through a radio frequency link for example of the Bluetooth type, to the portable computer 15 for example of the palmtop type, that acquires the data and interprets the flexural-vibrational behaviour, in terms of resonance and damping of the vibrations overall, producing information relating to the condition and soundness of the pole 20.

A procedure is implemented in the portable computer 15 that transposes the behavioural model of the pole in a condition of danger or one of normal operation onto the computer. This behavioural model is initialised on the basis of preliminary observations, including observations of an experimental type, on the sections and on the dynamic response of a “sound” pole and those of a “critical” pole, as well as on a zero test of the physical system: the mechanical properties evolve, from the assumed value in the critical section, along the vertical axis (in the upwards direction) according to a trend determined on the basis of these preliminary observations.

Stressing of the pole 20 by means of the percussion device 16 may be repeated a number of times: these successive and independent applications of energy enable a series of measurements to be acquired, thus providing a check of the reliability of the test results.

Alternatively, in a more general way the distribution of the mechanical characteristics is determined, minimising the difference between measured eigenfrequencies and/or resonance frequencies and those calculated by the mathematical model.

The response may simply be an indication according to two threshold levels that determine three regions, as shown in FIG. 2, where a diagram is shown on a display 19 of the portable computer 15 that presents:
a first region R1 relating to the system in a safety status;
a second region R2 relating to the system in an alert status;
a third region R3 relating to the system in a danger status.
On the display 19, the complete dynamic response may also be shown in terms of numerical strings and diagrams, if desired relating to the tests carried out, for example, the previous year or the previous season. In other words, historical data may be stored on the portable computer 15 relating to the specific individual pole.

The test report is produced by the model that interprets the data comparing them to those of the “sound” system and of the system with different degrees of “damage”.

In particular, the model takes into account the presence of the wires carried by the pole, of the stratification of the properties of the material along the vertical axis and of the pertaining ground constraining the pole: dampening, plasticity, additional mass, etc.

These data may be transferred, for example via a GSM, GPRS, GPS or UMTS link, to a central computer in the operative control center for storage and post-processing.

An info-transponder may also be provided for, that is a transponder with a writeable memory applied to the pole at the end of the test, so as to be able to store the results of the test and the date on which it was carried out, in the transponder on the pole itself.

Of course, the system is also applicable to poles of materials other than wood, but more in general to structural members positioned in the ground.

The equation that models the behaviour of the system is:

$$ρ A \frac{{\partial }^{2} u}{\partial {t}^{2}} + \frac{{\partial }^{2}}{\partial {z}^{2}} ( EI \frac{{\partial }^{2} u}{\partial {z}^{2}} ) + {k}_{t} ( z ) u = 0$$

where ρ indicates the density of the pole 20, E is the modulus of elasticity of the pole 20, I is the moment of inertia of the pole 20, A is the area of the axial section of the pole 20, and kₜ is the elastic constant of the ground.

The products ρA and EI are functions of the axial co-ordinate z, along the principal axis of the pole 20. For each pair of these functions, there is a succession of eigenfrequencies, and vice versa.

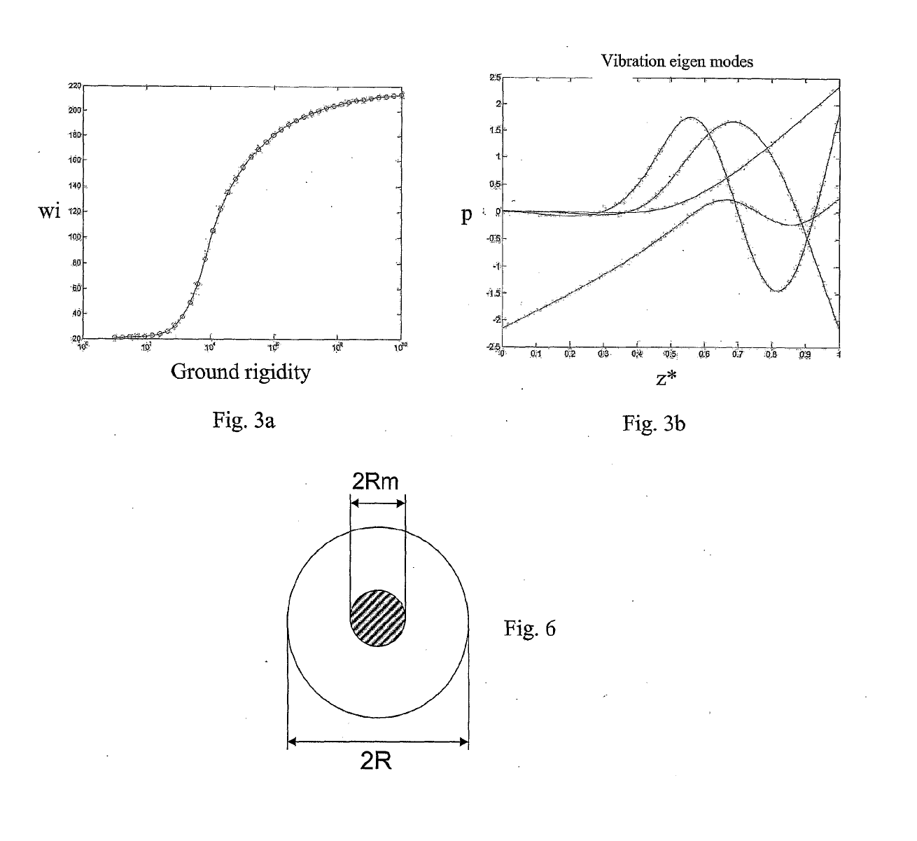

FIG. 3a shows, as an illustration, a resonance frequency wᵢ as a function of the rigidity of the ground.

FIG. 3b shows, as a function of the co-ordinate z normalised to the length of the pole 20, indicated with z*, the modes of vibration of the pole 20, indicated through the Lagrangian co-ordinate of displacement p.

With a “zero test” carried out on a sound pole (for example one just installed) the zero dynamic response is determined, that is the mechanical characteristics of the material system starting from the measurement of its eigenfrequencies and/or its resonant frequencies.

From subsequent measurements of the eigenfrequencies and/or resonance frequencies, the variations of said characteristics along the vertical axis can be determined, and thus the damage produced by degradation due to wood-eating insects and fungi. Above a certain threshold level, the pole is declared to be in danger.

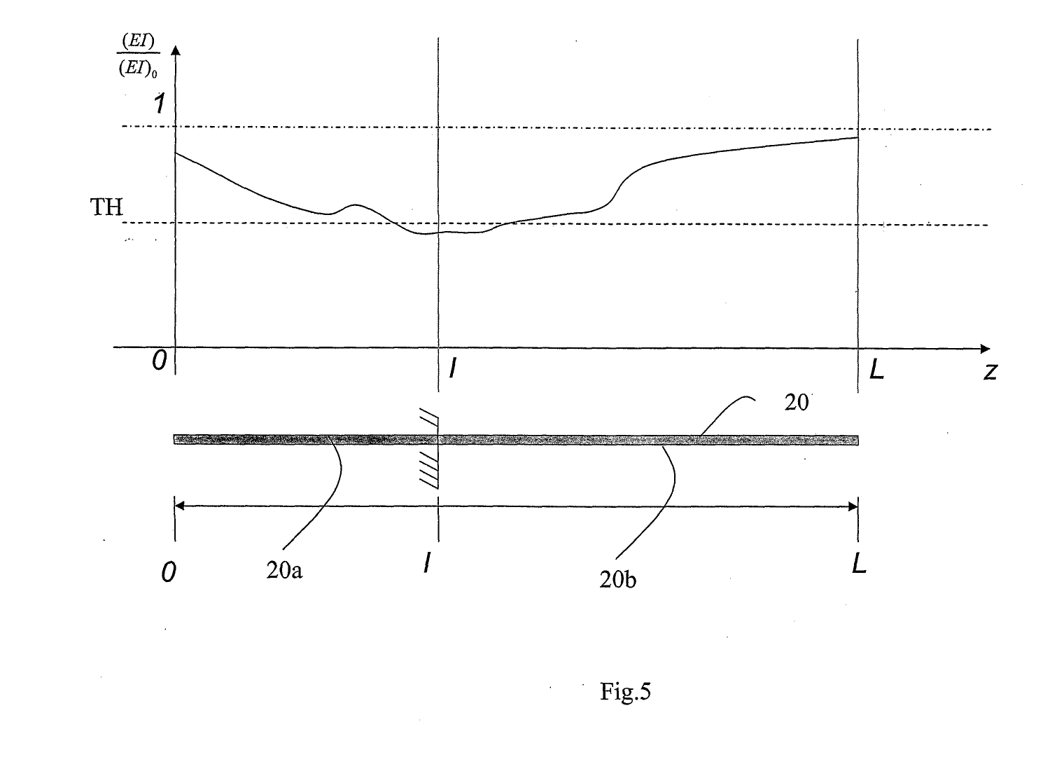

In this connection, as an example, FIG. 5 shows a possible trend of the ratio EI/(EI)₀ in the pole 20, as a function of the axial co-ordinate z, where (EI)₀ indicates the value of the product of the modulus of elasticity and the moment of inertia acquired through the above-mentioned “zero test” performed on a sound pole, and EI clearly corresponds to the product of the modulus of elasticity and the moment of inertia measured at a subsequent time, employing the kit according to the invention. In FIG. 5, for a better understanding, the pole 20 is shown parallel to the axis z and including a buried portion 20a of length l, up to the constraint interface with the ground, and a free portion 20b of length L-1, where L is the overall length of the pole 20.

In the diagram in FIG. 5, a crisis threshold is indicated with TH that, in the example shown, is passed in the area around the constraint interface of the pole 20 with the ground.

After having determined the function, product between the modulus of elasticity and the moment of inertia EI along the co-ordinate z, that is the longitudinal axis of the pole 20, it is possible to regard the damaged portion as an equivalent circle of reduced radius Rₘ, as shown in FIG. 6. Applying the following relations:

$$I ∝ {R}^{4} - {R}_{m}^{4}$$

$${I}_{0} ∝ {R}^{4}$$

$$\frac{I}{{I}_{0}} ∝ \frac{R - {R}_{m}^{4}}{{R}_{4}}$$

$$\frac{{R}_{m}}{R} = {( 1 - \frac{I}{{I}_{0}} )}^{1 / 4}$$

it may be seen that the process can be employed to provide this reduced radius Rₘ as output measurement and equivalent evaluation of the damage, once the product EI has been determined. It is then possible, on the basis of the crisis threshold TH shown in FIG. 5, to define a reduced threshold radius, below which the pole is to be replaced.

In a possible variant, the percussion device or source of energy may also, for example, be an inertial shaker or in any case, in general, a system of external stresses capable of determining the overall dynamic behaviour of the material system, such as for example the action of wind or of vibrations in any case present in the ground.

Furthermore, the number of detection modules, that is of sensors associated with the pole, may be more than one for the purpose of acquiring dynamic information at different stations along the vertical axis of the pole and thus avoid incuring in a node of a modal form.

The detection module may employ acceleration sensors obtained through accelerometers of different types or other measurement elements capable for example of evaluating the velocity of propagation of sound waves in the material and hence of determining the elastic modulus of the pole.

The measurement elements may in any case be of a different type, taking into account that it is known that in an elastic solid two types of basic waves are propagated:

P waves or pressure waves or compression waves;

S waves or shear waves.

There are also other types of waves (for example Rayleigh waves or Lamb waves). Each family of these waves is propagated with a different velocity and carries its own part of energy, which can be measured with appropriate measurement elements.

These measurement elements, according to a characteristic of the invention, are fixed to the collar and are not invasive with regard to the pole, that is they are applied for measurement in an easily removable manner.

The solution just described enables marked achieving advantages with respect to known solutions.

The kit according to the invention, to advantage, is light, since it may weigh less than 1 kilogram, and presents great facility of use by adopting the user interface of a portable computer that is intuitive, and through the possibility of repeating the test procedure immediately.

Advantageously, the kit according to the intervention presents, compared to known techniques, advantages in terms of economy and portability, since the kit comprises simple components that are reliable and of small size, and that can be placed in a water-proof carrying case.

Furthermore, to advantage, the kit according to the invention enables measurements to be made whose nature is non-local and that are not invasive. The possibility of obtaining a response relating to the entire length of the pole makes it possible to avoid excavation to free the part of the pole that is set into the ground, in order to access it with probes.

To advantage, the presence of a collar equipped with sensors, in particular as an alternative to the insertion of sensors into the wood, does not influence the validity of the results since the flexural movements of the pole are measured (in which each section rotates rigidly). Thus application and removal of the collar with its sensors does not compromise the measurements.

Of course, without obtaining the principle of the invention, details of production and embodiments may be widely varied with regard to what is described and illustrated, without thereby departing from the scope of the invention. In this connection, the fact is once again mentioned that, although for simplicity of illustration in this description almost constant reference has been made to the possibility of applying the invention in one context, the scope of the invention is entirely general and thus is not limited to the specific application context.

For example, the collar can be replaced by any type of support capable of providing an equivalent function of bearing the sensors in good contact with the pole and in a removable manner, or in a condition capable of making measurements, and supporting at the same time the wireless transceiver. Hence the shape of the collar to be tightened onto the pole through a fastening or buckle is preferred, however other forms will be possible, for example a hemi-circumference of resilient material closed by means of a clamping mechanism that in any case maintains the features of non-invasiveness inside the pole.

1. Kit for monitoring poles, in particular wooden poles, that comprises:
a detection device including at least one collar
to be secured to a pole to be evaluated, said at least one collar bearing one or more sensors
capable of detecting a response determined by the percussion of said pole,
a percussion device to stress said pole and determine said response;
a data transmission system in signal connection with said one or more sensors to receive the measured values from them;
a portable computer to receive and process the data transmitted through said data transmission system
by the detection device to monitor the damage produced by degradation.

2. Kit according to claim 1, characterised in that said percussion device is an instrumented and/or calibrated percussion hammer.

3. Kit according to claim 1, characterised in that it includes a power supply, in particular a power supply using rechargeable batteries.

4. Kit according to claim 3, characterised in that said power supply is associated to said collar.

5. Kit according to claim 1, characterised in that it includes a carrying case for transport.

6. Kit according to claim 1, characterised in that said portable computer is a palmtop or notebook computer.

7. Kit according to claim 1, characterised in that said response determined by the percussion of said pole is a response of the mechanical type.

8. Kit according to claim 7, characterised in that said sensors comprise acceleration sensors.

9. Kit according to claim 1, characterised in that said response determined by the percussion of said pole a response of the acoustic type.

10. Kit according to claim 1, characterised in that said sensors comprise sensors to measure the acoustic response in terms of the velocity of propagation of sound waves in the pole.

11. Kit according to claim 1, characterised in that said data transmission system is of the wireless type, in particular operating a radiofrequency.

12. Kit according to claim 1, characterised in that said collar includes associated with it said data transmission system in signal connection with said one or more sensors to receive the measured values from them.

13. Monitoring process to monitor poles, in particular wooden poles, that envisage arranging one or more sensors in a condition suitable for measuring a response determined by the percussion of the pole to be evaluated, in particular in contact with said pole, applying percussion to stress said pole, measuring the effects of said percussion through said sensors characterised in that said operation of arranging one or more sensors includes preliminary arranging said sensors associated with at least one removable collar and securing said collar to said pole placing said sensors in a condition suitable for measuring said pole, in particular in contact; said operation of applying percussion comprises directly striking said pole to solicit a response, said sensors measuring data useful to determine
said response; said procedure also including: transmitting measurements from said one or more sensors
in a data transfer system, in particular of the wireless type, associated to said, collar; acquiring and processing said measurements from said one or more sensors in a portable computer.

14. Process according to claim 13, characterised in that it also includes the operation of performing a zero test on a sound pole to determine a zero response,

15. Process according to claim 13, characterised in that said operation of acquiring and processing said measurements from said one or more sensors in a portable computer includes the operation of calculating eigenfrequencies and/or resonance frequencies of said response to the percussion.

16. Process according to claim 13, characterised in that said operation of acquiring and processing said measurements from said one or more sensors in a portable computer includes the operation of calculating the velocity of propagation of sound waves from said response to the percussion.

17. Process according to claim 15, characterised in that said operation of acquiring and processing said measurements from said one or more sensors in a portable computer includes the operation of calculating, on the basis of said eigenfrequencies or resonance frequencies or the velocity of propagation of sound waves, mechanical characteristics (EI, (EI)₀) of the pole along a longitudinal axis (z).

18. Process according to claim 17, characterised in that said operation of acquiring and processing said measurements from said one or more sensors in a portable computer includes comparing said mechanical characteristics (EI, (EI)₀) with threshold values (TH, Rₘ).

19. Process according to claim 1S, characterised in that said operation of acquiring and processing said measurements from said one or more sensors in a portable computer envisages calculating a reduced radius of the pole (Rₘ) as a function of said mechanical characteristics (EI, (EI)₀).

20. Process according to claim 13, characterised in that said operation of acquiring and processing said measurements from said one or more sensors in a portable computer includes storing historical data concerning one or more poles.

21. Process according to claim 13, characterised in that the processed data are transferred to an operative center.

22. Process according to claim 13, characterised in that said operation of applying percussion includes stressing actions applied by natural agents, in particular the wind.

23. Process according to claim 13, characterised in that it includes the operation of applying an info-transponder onto the pole and storing on the pole itself in said transponder, after the operation of acquiring and processing the data, the processed data and the date on which said monitoring procedure was performed.

24. Collar suitable of being secured to a pole, characterised in that it includes the features of the collar of the pole monitoring kit according to claim 1.

25. Computer program product directly loadable into the memory of a digital computer and including software code portions for performing the steps of the process according claim 13 when the computer program product is run on a digital computer.
